(19) United States
(12) Patent Application Publication
(10) Pub. No.: US 2010/0229403 A1
(43) Pub. Date: Sep. 16, 2010

(54) Cutter Head of a Manually Guided Implement

(75) Inventors: Norbert Apfel, Waiblingen (DE); Marc Theile, Fellbach (DE)

Correspondence Address: ROBERT W. BECKER & ASSOCIATES, 707 HIGHWAY 333, SUITE B, TIJERAS, NM, 87059-7507, US

(73) Assignee: Andreas Stihl AG & Co. KG, Waiblingen (DE)

(21) Appl. No.: 12/722,507

(22) Filed: Mar. 11, 2010

(30) Foreign Application Priority Data
Mar. 14, 2009 (DE) 10 2009 013 277.5

(51) Int. Cl. A01D 34/73

(52) U.S. Cl. 30/332; 30/347

(57) ABSTRACT

A cutter head of an implement, comprising a cutting blade rotatably drivable about an axis of rotation. The cutting blade is provided with at least two blade wings that extend along a longitudinal axis in a radial direction relative to the axis of rotation. The cutting blade is clamped between two contact or pressure pieces, at least one of which is provided with at least one radially extending dampening projection that rests against at least one of the blade wings.

The instant application should be granted the priority date of Mar. 14, 2009, the filing date of the corresponding German patent application 10 2009 013 277.5.

### BACKGROUND OF THE INVENTION

The present invention relates to a cutter head of a manually guided or portable implement.

Brushcutters or trimmers, lawn mowers or the like have a cutter head with a cutting blade that is rotatably drivable about an axis of rotation and that is clamped between two contact or pressure pieces. A first contact or pressure piece is formed by a so-called contact plate that is disposed on the side facing the motor and that has a centrally projecting shaft-end pivot. The cutting blade is placed upon the shaft-end pivot via a central shaft opening, and is brought into contact against the contact plate. Finally, the other contact or pressure piece, which is embodied in the form of a circular disk, is placed upon the shaft-end pivot and is preloaded in the axial direction relative to the contact plate, as a result of which the cutting blade is held between the two contact or pressure pieces in a clamping manner.

The cutting blade has at least two blade wings, which extend along a longitudinal axis in a radial direction relative to the axis of rotation. During operation, the cutting blade is rotated by the drive motor of the implement, whereby the driving torque from the two contact or pressure pieces is transferred to the cutting blade via a positive or frictional connection. The drive motor, which is in particular embodied as a one-cylinder internal combustion engine, produces a non-uniform torque, which acts upon the cutting blade as an oscillation excitation or singing. The cutting edges of the cutting blade strike the material that is to be cut, which similarly leads to a non-uniform loading of the cutting blade and hence to an oscillation excitation or singing. The type of construction of the blade wings, which are longitudinally extended in the radial direction, brings about an elastic resilience, resulting in a system that is capable of oscillating. The aforementioned oscillation excitations can lead to undesired oscillations or vibrations of the cutting blade and its blade wings during operation.

The object of the present application is to improve a cutter head of the aforementioned general type in such a way that the ability of the cutting blade to produce oscillations is reduced.

### BRIEF DESCRIPTION OF THE DRAWINGS

This object, and other objects and advantages of the present application, will appear more clearly from the following specification in conjunction with the accompanying schematic drawings, in which:

FIG. 1 is a perspective view of a partially schematically illustrated, manually guided implement according to the prior art by way of example of a brushcutter having a cutter head, and including circular disk shaped contact or pressure pieces;

FIG. 2 is a side view of one exemplary further development of the cutter head of FIG. 1 pursuant to the present invention that includes a contact or pressure piece having a dampening portion;

FIG. 3: is a perspective view of the contact or pressure piece of FIG. 2 showing details of its geometrical configuration;

FIG. 4: is a plan view onto the cutter head of FIG. 2 with details relating to the cooperation between the contact or pressure piece and the cutting blade;

FIG. 5: is a schematic plan view of a variant of the arrangement of FIG. 4 with optional protection against rotation on both sides;

FIG. 6: is a schematic illustration of a further variant of the embodiment of FIG. 4 or of FIG. 5 that includes a positive-connection protection against rotation in the hub portion;

FIG. 7: shows a further variant of the arrangement according to FIGS. 4 to 6 with an opening in the dampening projection as a measure for the reduction of the mass;

FIG. 8 shows a modification of the embodiment of FIG. 7 with a recessed portion instead of the opening;

FIG. 9 shows a further schematically illustrated embodiment having a plurality of dampening projections that are layered one over the other in a lamellar manner;

FIG. 10: is a schematic longitudinally sectioned illustration showing the inventively embodied cutter head with planar blade wings and dampening projections that rest against one another in a flat manner;

FIG. 11: shows a variant of the arrangement of FIG. 10 with a radially outwardly flattened dampening portion of the contact or pressure piece;

FIG. 12 shows a modification of the arrangement of FIG. 10 or of FIG. 11 with a contact or pressure piece that is embodied as a deep drawn part and has a circumferential edge that rests against the blade wing; and

FIG. 13 shows a variant of the arrangement of FIG. 12 with a contact or pressure piece that rests against the blade wing at only its radially outer end.

### SUMMARY OF THE INVENTION

Pursuant to the present application, a cutter head of an implement is proposed that comprises: a cutting blade rotatably drivable about an axis of rotation, the cutting blade being provided with at least two blade wings that extend along a longitudinal axis in a radial direction relative to the axis of rotation; and two contact or pressure pieces between which the cutting blade is clamped, wherein at least one of the contact or pressure pieces is provided with at least one radially extending dampening projection that rests against at least one of the blade wings.

The contact or pressure piece preferably has a respective radial dampening projection for each blade wing. Consequently, the contact or pressure piece of the present application deviates from the hereto fore known circular shape, and in the direction of the blade wing or blade wings has a longitudinally extended shape. Due to the abutment against the blade wing, the radially projecting dampening portion of the dampening projection prevents the formation of an in particular harmonic oscillation of the blade wing. In addition, the flat or laminar abutment acts as a friction dampener. The type of construction of the dampening projection, which is longitudinally extended in the radial direction, causes an only slight application of mass that is capable of natural oscillation. On the whole, the tendency of the blade wings toward oscillations is thereby significantly reduced or even entirely eliminated.

Pursuant to one preferred embodiment, a hub portion of the contact or pressure piece delimits a clamping circle having a radius relative to the axis of rotation. A radially outermost point of the dampening projection is disposed in a radius relative to the axis of rotation. The radius of the radially outermost point is at least 1.5 times, and preferably at least twice, e.g. at least three times, as great as the radius of the clamping circle. The longitudinally extended type of construction of the dampening projection prescribed hereby adequately produces the desired effect of a suppression or dampening of an oscillation excitation.

It can be expedient for both of the contact or pressure pieces, or the contact or pressure piece that is on the motor side and is embodied as a contact plate, to be provided with radial dampening projections. Preferably, however, the first contact or pressure piece, in the form of a contact plate on the motor side, has a circular disk shape, while the second contact or pressure piece, disposed on the opposite side, is provided with the at least one radially extending dampening projection. This enables the use of already existing implements with unmodified tool heads and contact plates. It is then merely necessary to configure the contact or pressure piece that is placed on the outer side in the inventive design with dampening projections, whereupon such contact or pressure piece can then be used as a replacement for the existing, circular disk shaped contact or pressure pieces of existing implements. Furthermore, the unmodified contact plate permits the installation of other tools where the use of contact or pressure pieces having dampening projections is not required or not desired.

It can be expedient for the longitudinal axis of the dampening projection to be aligned with the longitudinal axis of the blade wing. Preferably, however, the longitudinal axis of the dampening projection is angularly offset relative to the longitudinal axis of the blade wing. A nonsymmetrical arrangement results that makes the formation of natural oscillations in the blade wing more difficult, thereby increasing the effectiveness of the arrangement.

Pursuant to one advantageous further development, a protection against rotation, which in particular acts in both directions of rotation, is provided between the cutting blade and the contact or pressure piece having the at least one radially extending dampening projection. Sudden loads or the like that are unavoidable during operation cannot lead to a sliding-through of the cutting blade relative to the contact or pressure piece. Both components permanently remain in the prescribed relative rotational angle positions relative to one another, as a result of which the action of the oscillation excitation suppression is permanently maintained.

The protection against rotation can be embodied in the form of a rivet, weld or adhesive connection. A positive connection protection against rotation, in particular in the form of a bent-over tab, is preferably provided between the radially extending dampening projection and the associated blade wing. Contact or pressure piece and cutting blade can be easily separated from one another, in particular during maintenance. Furthermore, a minimal relative moveability remains between the two components, resulting in a frictional dampening effect.

Measures to reduce mass are advantageously undertaken at the dampening projection in a dampening portion that is disclosed radially outwardly of the hub portion; such measures for the reduction of mass are in particular in the form of width and/or thickness reduction, recessed portions, openings and/or the like. In so doing, not only is the overall mass of the rotating system reduced in a desired manner. Rather, the mass reduction in the radially outer dampening portion alters the natural oscillations of the dampening projection in mode and frequency.

It can be expedient to construct the contact or pressure piece with the dampening projections as a monolithic part and to use it as a piece part. Pursuant to one advantageous variant, a plurality of dampening projections, or contact or pressure pieces having such dampening projections, in particular with different radial extensions, are stacked one above the other. As a supplement to the aforementioned advantageous effects, an additional dampening effect, comparable to that of a leaf type spring set, is obtained, according to which the individual elements, which are layered one above the other in a lamellar manner, rub against one another and thereby dissipate oscillation excitation energy that has been introduced.

It can be advantageous to embody the cutting blade, and the contact or pressure piece that is provided with the dampening projections, to on the whole be planar, whereby the two components rest against one another in a flat or laminar manner. Pursuant to one preferred variant, a radially outer end of the dampening projection is angled off toward the blade wing and rests with preload against the blade wing. This ensures that this abutment is maintained even when there is an elastic deflection of the blade wing that proceeds from the dampening projection. There results at the radially outer end a precisely defined abutment region having the desired effect of a suppression of the oscillation excitation, which enables a precise adaption of the inherent frequencies of the overall system to the excitation frequencies that are encountered, and which facilitates the prevention of the formation of operational oscillation excitations.

Pursuant to one advantageous further development, at least the dampening projection, and in particular the contact or pressure piece having the at least one dampening projection, is entirely made of a light weight material, especially titanium, the specific mass of which is less than the specific mass of the cutting blade. This contributes positively to the shifting of the inherent frequencies and natural modes of the oscillating system to noncritical regions.

Pursuant to one preferred embodiment, measures that increase the frictional value are undertaken on that side of the dampening projection that faces the blade wing. On the one hand, by doing so a slipping of the dampening projection relative to the blade wing is avoided. One the other hand, by means of a frictional relative movement during oscillation excitation, an increased portion of the oscillation excitation energy is dissipated by friction.

A protection against losing the contact or pressure piece having the at least one dampening projection relative to the cutting blade is advantageously provided. During replacement of the cutting blade, or during maintenance work thereon, the contact or pressure piece cannot become lost. In addition, the protection against losing holds the dampening projection in the prescribed rotational angle position relative to the blade wing, thus avoiding incorrect assembly.

Further specific features of the present invention will be described in detail subsequently.

### DESCRIPTION OF SPECIFIC EMBODIMENTS

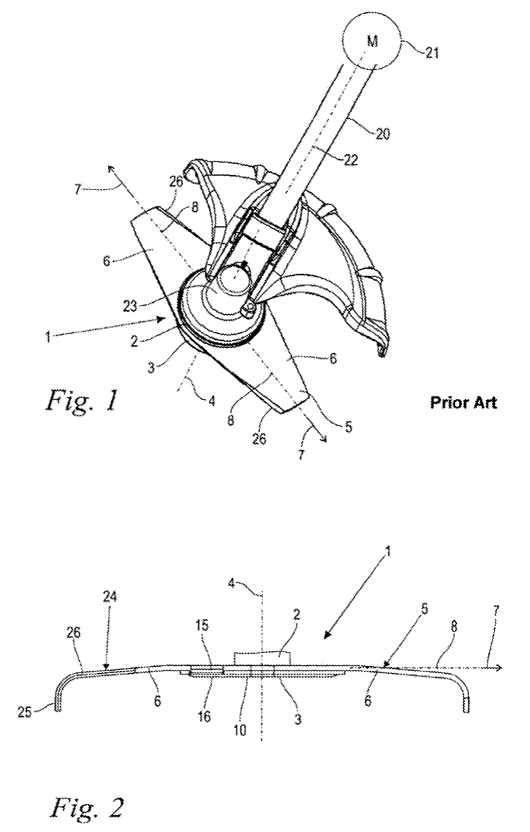

Referring now to the drawings in detail, the perspective view of a partially schematically illustrated, manually guided or portable implement shown in FIG. 1 by way of example of a brushcutter, includes a blade or cutter head 1 and an indicated drive motor 21. The drive motor 21 is an internal combustion engine, although it can also be an electric motor for the power supply or battery operation. Furthermore, other motor-driven implements, such as a manually guided lawn mower, a riding mower, or the like can also be provided. The drive motor 21 rotatably drives a non-illustrated drive shaft that is guided in a guide tube 20. Disposed at that end of the guide tube 20 that is opposite the drive motor 21 is a gear mechanism head 23 having a miter gear. There, the rotational movement of the drive shaft in the guide tube 20 is transferred to the cutter head 1.

The cutter head 1 includes two contact or pressure pieces 2,3, whereby the upper contact or pressure piece 2, which faces the drive motor 21, is embodied as a contact plate, and the opposite contact or pressure piece 3, which is remote from the drive motor 21 and the gear mechanism head 23, is embodied as a clamping plate. Pursuant to the state of the art, both of the contact or pressure pieces 2, 3, in conformity with the illustration of FIG. 1, have the shape of a circular disk. A cutting blade 5 of plate steel is disposed between the contact or pressure pieces 2,3. The cutting blade 5 is rotatingly driven about an axis of rotation 4 by frictional contact with the contact or pressure pieces 2,3, and together therewith.

The cutting blade 5 has two blade wings 6, which are disposed diametrically cross from one another relative to the axis of rotation 4, and which each extend along a longitudinal axis 8 in a radial direction 7 relative to the axis of rotation 4 (see also FIG. 4). During operation, cutting edges 26 of the blade wings 6 strike the material that is to be cut. The sudden loads that thereby result, and also a non-uniform driving torque of the drive motor 21, which is in particular embodied as a one-cylinder internal combustion engine, produce oscillation excitations, whichcan lead to the formation of vibrations in the blade wings 6.

The side view of FIG. 2 shows an inventively improved cutter head 1 according to FIG. 1 having a cutting blade 5 of plate steel that, as is the case with the prior art device of FIG. 1, is disposed between two contact or pressure pieces 2, 3. In correspondence with the design of FIG. 1, the upper, first contact or pressure piece 2 on the motor side is embodied as a contact plate having the shape of a circular disk. A further correspondence with the design of FIG. 1 is that at least two blade wings 6 of the cutting blade 5 are provided that extend along a longitudinal axis 8 in a radial direction 7 relative to the axis of rotation 4, and that are provided with cutting edges 26 in a radially outer cutting region 24. However, embodiments of the cutting blade 5 having three, four or more blade wings 6 distributed over the periphery can also be expedient. In a departure from the design of FIG. 1, the blade wings 6 of FIG. 2 can optionally additionally be provided with radially outwardly disposed cutting ends 25 that are bent downwardly toward the material that is to be cut, and in particular parallel to the axis of rotation 4, and over which a respective cutting edge 26 extends. Instead of the illustrated inventive cutter head 1 for a brushcutter or trimmer according to claim 1, such a cutter head can also be provided for a lawn mower or the like.

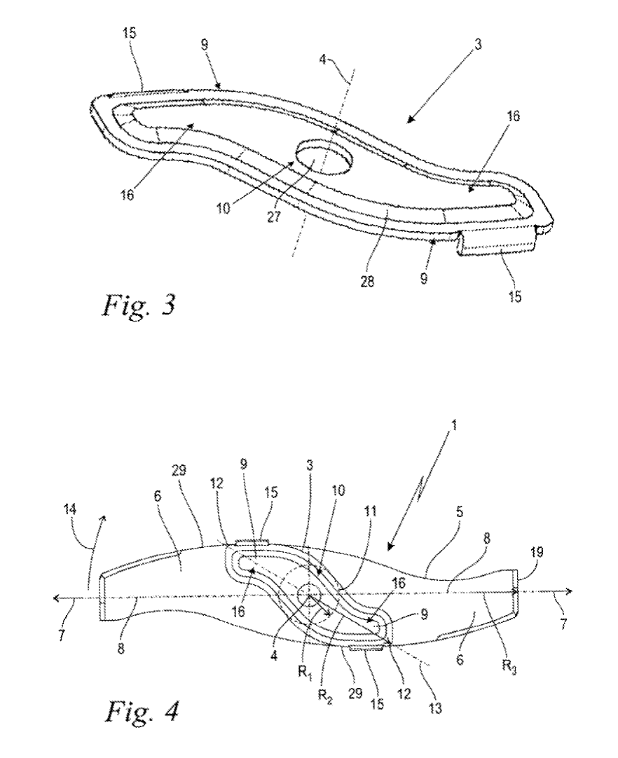

The second contact or pressure piece 3 of the present application, which is disposed across from the first contact or pressure piece 2, which is embodied as a contact plate, is embodied differently from the prior art of FIG. 1 and has a radially inner hub portion 10 as well as a radially outer dampening portion 16. Details of the configuration of the second contact or pressure piece 3 can be see from the perspective illustration of FIG. 3, pursuant to which the contact or pressure piece 3, in its radially inner hub portion 10, is provided with a shaft opening 27, which is disposed concentric to the axis of rotation 4, and by means of which the contact or pressure piece 3, as is the cutting blade 5 (FIG. 2), are placed or mounted on a non-illustrated shaft-end pivot of the cutter head 1 (FIG. 2) and can thereby be centered. Disposed radially outwardly of the hub portion 10 is the dampening portion 16, which is formed by at least one dampening projection 9 of the contact or pressure piece 3. In the illustrated embodiment, two dampening projections 9 are provided that are disposed rotationally symmetrical relative to the axis of rotation 4 and hence diametrically across from one another; each of the dampening projections 9 is associated with one of the two blade wings 6 of FIG. 2. If a greater number of blade wings 6 (FIG. 2) is provided, a greater number of dampening projections 9 can also be expedient, according to which the contact or pressure piece 3 has a respective radial dampening projection 9 for each blade wing 6 (FIG. 2).

The inventively configured contact or pressure piece 3 of FIG. 3 can be a cast or milled part, and in the illustrated embodiment is a stamped sheet-metal part having an essentially planar basic shape. For reinforcement purposes, a circumferential reinforcing bead 28 is stamped into the sheet-metal part. In addition, the radially outer dampening portion 16 of the contact or pressure piece 3, on all of the dampening projections 9, is provided with a respective bent-over tab 15, the function of which will be described subsequently in conjunction with FIG. 4. The plate steel, from which the cutting blade 5 with its blade means 6 is formed, has a specific mass of approximately 7.8 g/cm³. At least the dampening projection 9, here the contact or pressure piece 3 with the dampening projections 9, is on the whole made of a material that is lighter in comparison thereto and that has a lower specific mass. This lighter material can be aluminum or the like, and in the illustrated embodiment it is titanium having a specific mass of approximately 4.5 g/cm³.

FIG. 4 shows a plan view onto the cutter head 1 of FIG. 2 having the contact or pressure piece 3 of FIG. 3. The hub portion 10 of the contact or pressure piece 3 delimits a clamping circle 11 having a radius R₁. This means that the clamping circle 11 has the maximum possible radius R₁ without extending beyond the peripheral contour of the contact or pressure piece 3. The function of the hub portion 10, which is surrounded by the clamping circle 11, corresponds to that of the circular disk shaped contact or pressure piece 3 of FIG. 1. The respective dampening projections 9 are disposed in the dampening portion 16, which is disposed radially outwardly of the clamping circle 11. Radially outermost points 12 of the dampening projections 9 are disposed at a radius R₂ relative to the axis of rotation 4. The radius R₂ of the radially outermost points 12 is at least 1.5 times as great, and preferably at lease two times as great, as the radius R₁ of the clamping circle 11, and in the illustrated embodiment is approximately three times as great. Radially outer ends 19 of the blade wings 6 are disposed at a radius R₃ relative to the axis of rotation 4. The radius R₂ of the outer points 12 of the dampening projections 9 is advantageously at least 0.3 times the radius R₃, and in the illustrated embodiment is advantageously disposed in a range between 0.4 and 0.5 times the radius R₃.

It can furthermore be seen from FIG. 4 that although the contact or pressure piece 3 with the dampening projections 9 is rotationally symmetrical relative to the axis of rotation 4, it is not mirror symmetrical to the longitudinal axes 13 of the dampening projections 9 that extend through the outermost points 12. Rather, the contact or pressure piece 3 has a configuration that is curved in an approximately S-shaped manner. Furthermore, it can also be seen that the longitudinal axes 13 of the contact or pressure pieces 3, i.e. of the dampening projections 9, are not aligned with the longitudinal axes 8 of the blade wings 6, but rather in the plane of rotation are offset relative thereto by a specific angle.

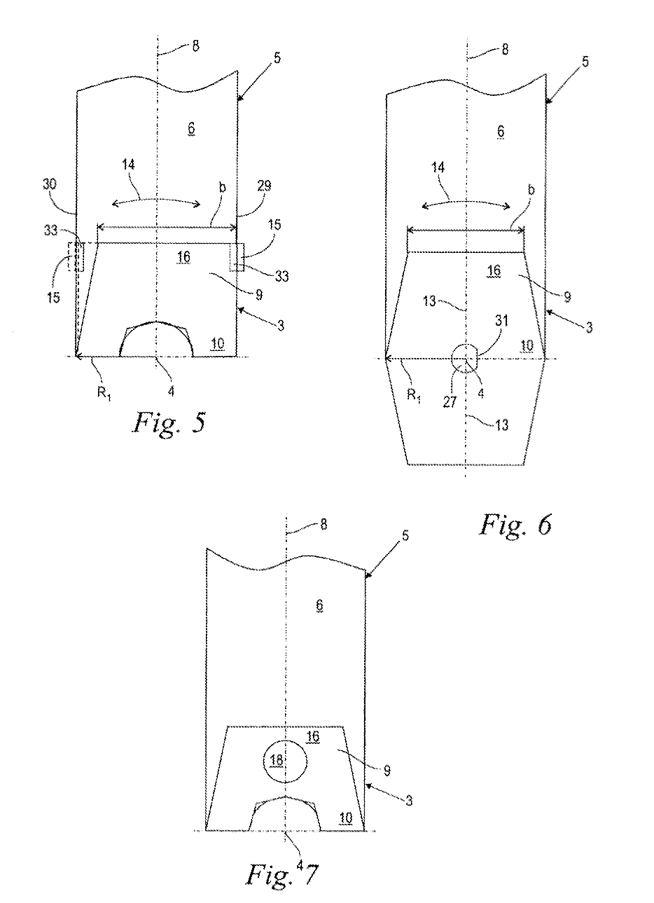

The tabs 15, which are illustrated in greater detail in FIG. 3, extend about associated edges 29 of the blade wings 6, as can also be seen in the side view of FIG. 2. As a result, a protection against rotation of the contact or pressure piece 3 relative to the cutting blade 5 is provided that acts with reference to the direction of rotation 14 of the cutter head 1 that is indicated by the arrow. In the illustrated embodiment, this protection against rotation acts in only one direction of rotation. However, in conformity with the illustration of FIGS. 5 and 6 that are described in detail subsequently, a protection against rotation can also be provided that additionally acts in the opposite relative direction of rotation with reference to the direction of rotation 14. The protection against rotation between the radial dampening projections 9 and the respectively associated blade wings 6 is, by means of the bent over tabs 15, a positive connection with reference to the direction of rotation 14. A reverse configuration can also be expedient, according to which the tabs are disposed on the respective blade wings 6 and extend about an edge of the dampening projections 9.

The schematic plan views of FIGS. 5 to 9 show different variations of the contact or pressure piece 3 with a dampening projection 9 in the interaction with the associated blade wings 6. To facilitate illustration, in each case only one half of the blade is shown, whereby the dampening projection 9 is shown shorter than it would be in a practical configuration. In the embodiment of FIG. 5, in the region of the axis of rotation 4 the contact or pressure piece 3 has a width that is double the radius R₁. Proceeding from here, the dampening projection 9 tapers on one side in a radially outer direction, as a result of which it has a width b at its radially outer end. This width b is less than twice the radius R1. This reduction in width acts as a measure to reduce the mass of the contact or pressure piece 3 in its dampening portion 16, which is disposed radially beyond the hub portion 10. In addition, the tab 15 extends about the edge 29 of the blade wing 6. Consequently, the previously described features of the configuration of FIG. 5 correspond in principle to the construction of FIGS. 2 to 4. However, an additional tab 15 or other suitable means can optionally also be provided on the dampening projections 9 or at other suitable locations to produce a positive connection with the blade wings 6, in particular at its opposite edge 30. In this case, a protection against rotation between the contact or pressure piece 3 and the respective blade wing 6 is formed in both directions of rotation 14.

Additionally, a protection against losing the contact or pressure piece 3, with its dampening projections 9, relative to the cutting blade 5 can optionally be provided. In the illustrated embodiment, for this purpose the tabs 15 are flanged about the blade wings 6, so that additional tabs 33 extend about the blade wings 6 and thereby rest against the flat side of the blade wings 6 disposed across from the main body of the contact or pressure piece 3. Instead of such a flanging or some other suitable measure for providing a positive connection, or alternatively in addition thereto, an adhesive connection, soldering and/or welding, in particular in the form of spot welding, can be provided as a protection against losing.

FIG. 6 shows a variation of the arrangement of FIG. 5, with a width reduction of the contact or pressure piece 3 in its dampening portion 16 relative to the hub portion 10 also being provided. The inclines provided for this purpose are disposed on both sides of the blade wing 6, and are formed symmetrically relative to the longitudinal axis 13 of the dampening projection 9. A reduced width b also results from this measure. With the illustrated symmetrical configuration, the longitudinal axis 13 of the dampening projection 9 is aligned with the longitudinal axis 8 of the blade wing 6. As a protection against rotation between the contact or pressure piece 3 and the cutting blade 5, the shaft opening 27 of the contact or pressure piece 3 has a flattened portion 31, whereby the non-illustrated shaft-end pivot that is guided through the shaft opening 27 is provided with a cross-section having the same shape. A central opening in the cutting blade 5 is formed in the same manner, as a result of which the cutting blade 5 and the contact or pressure piece 3 are fixed in their angular position relative to the shaft-end pivot, and therefore also cannot rotate relative to one another. The protection against rotation formed thereby acts in both directions of rotation 14.

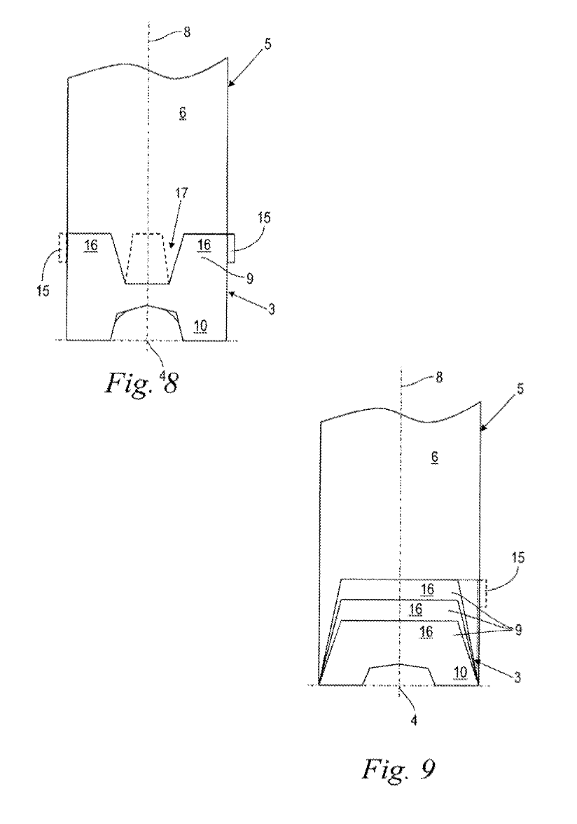

FIG. 7 shows a variation of the arrangement of FIG. 6, according to which an opening 18 is provided as an additional measure to reduce the mass in the radially outer dampening portion 16. A protection against rotation is not explicitly illustrated here. As an alternative to the aforementioned options, a protection against rotation can, for example, be produced by riveting, welding or adhesion of the contact or pressure piece 3 with the cutting blade 5. A further variation is additionally illustrated in FIG. 8, where instead of the opening 18 (FIG. 7) a radially outwardly open recessed portion 17 is provided. The protection against rotation is here provided in a manner analogous to the configuration described in conjunction with FIG. 5.

A further optional embodiment is illustrated in FIG. 9, according to which a plurality of dampening projections 9, which are formed as individual parts, are stacked one above the other in a lamellar manner. The dampening projections 9 can have the same length. However, in the illustrated embodiment they have a different radial extent, here stepped in a cascade-like manner, whereby the dampening projection 9 that rests directly against the blade wing 6 has the greatest length in the radial direction, and the uppermost dampening projection 9 that is opposite in the stacked sequence has the shortest length. Here also one or all of the illustrated dampening projections 9 can have a protection against rotation, for example in the form of the tab 15 that is indicated by dashed lines, or in some other suitable fashion.

To the extent not otherwise described, the embodiments of FIGS. 2 to 9 coincide with one another with respect to their remaining features and reference numerals.

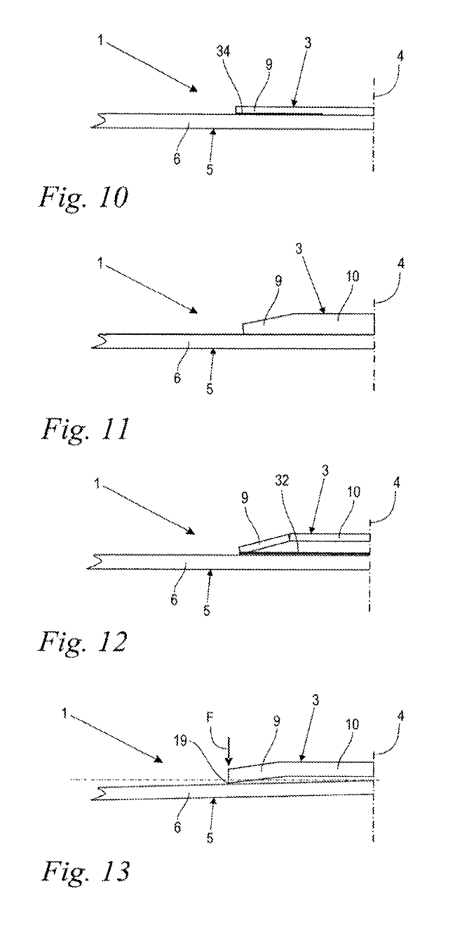

The schematic cross-sectional illustrations of FIGS. 10 to 13 show various embodiments of the cutter heads 1 of FIGS. 2 to 9. In the embodiment of FIG. 10, the blade wings 6 of the cutting blade 5, and also the contact or pressure piece 3 with its dampening projections 9, are shown as essentially planar, flat plates of sheet metal that each have a uniform thickness. To facilitate illustration, and also due to the symmetry relative to the axis of rotation 4, only the region of one blade wing 6 and of one dampening projection 9 is respectively illustrated, whereby, however, obviously the same applies for all further blade wings 6 and dampening projections 9. The dampening projection 9 of the contact or pressure piece 3 rests flat against the upper surface of the cutting blade 5, accompanied by axial preload. Optionally, measures that increase the frictional value can be provided at least on the dampening projection 9, and possibly also on the entire contact or pressure piece 3 on that side that faces the blade wings 6. For this purpose, schematically indicated is a coating 34 that is applied, for example by flame spraying, to increase the frictional value. The coating 34 can comprise a diamond, silicon carbide, or tungsten carbide coating, or of some other comparable, suitable material. In addition, either alternatively or in addition thereto, a measure that increases the frictional value in the form of a surface structuring can be provided.

FIG. 11 shows a variation of the arrangement of FIG. 10, according to which the contact or pressure piece 3 is provided radially beyond the clamping circle 11, in the dampening portion 16, with a thickness reduction that tapers continuously in an outward direction. This acts as a measure to reduce the mass of the dampening projection 9, and can be used as a supplement to the measures previously described in conjunction with FIGS. 5 to 9. The illustrated thickness-reducing cross-sectional shape can be provided by machining or from a casting standpoint. In the illustrated embodiment, for this purpose a dished sheet metal plate is advantageously provided.

In the modified embodiment of FIG. 12, the contact or pressure piece 3 is embodied as a deep drawn sheet metal part having a constant thickness, whereby the radially outer dampening portion 16 is deformed or shaped relative to the inner hub portion 10 comparable to a circumferential plate rim. A circumferential edge 32 results via which the contact or pressure piece 3 rests upon the cutting blade 5, and which elastically holds the hub portion 10 at a distance relative to the cutting blade 5. Alternatively, the embodiment according to FIG. 13 can be expedient, according to which the contact or pressure piece 3 is also produced as a deep drawn part from sheet metal. However, here only one radially outer end 19 of the dampening projection 9 is angled off relative to the blade wing 6, and rests against the blade wing 6 with preload in conformity with a force F. In so doing, also the blade wing 6 experiences an elastically resilient axial deflection relative to the radial direction 7.

With regard to the remaining features and numerals, the embodiments of FIGS. 10 to 13 coincide with one another as well as with FIGS. 2 to 9.

The specification incorporates by reference the disclosure of German priority document 10 2009 013 277.5 filed 14 Mar. 2009.

The present invention is, of course, in no way restricted to the specific disclosure of the specification and drawings, but also encompasses any modifications within the scope of the appended claims.

What we claim is:

1. A cutter head of an implement, comprising:
a cutting blade that is rotatably drivable about an axis of rotation, wherein said cutting blade is provided with at least two blade wings, and wherein said blade wings extend along a longitudinal axis in a radial direction relative to said axis of rotation; and
two contact or pressure pieces, wherein said cutting blade is clamped between said contact or pressure pieces, and wherein at least one of said contact or pressure pieces is provided with at least one radially extending dampening projection that rests against at least one of said blade wings.

2. A cutter head according to claim 1, wherein said at least one contact or pressure piece has a respective radially extending dampening projection for each of said blade wings.

3. A cutter head according to claim 1, wherein said at least one contact or pressure piece is provided with a hub portion that delimits a clamping circle having a radius relative to said axis of rotation, further wherein a radially outermost point of said at least one dampening projection is disposed in a further radius relative to said axis of rotation, and wherein said radius of said radially outermost point is at least 1.5 times as great as said radius of said clamping circle.

4. A cutter head according to claim 3, wherein said radius of said radially outermost point is at least twice as great as said radius of said clamping circle.

5. A cutter head according to claim 3, wherein said radius of said radially outermost point is at least three times as great as said radius of said clamping circle.

6. A cutter head according to claim 1, wherein a first one of said contact or pressure pieces is embodied as a contact plate having a circular disk shape and being disposed on a side of said cutting blade that faces a drive motor, and wherein a second one of said contact or pressure pieces is said contact or pressure piece that is provided with said at least one radially extending dampening projection.

7. A cutter head according to claim 1, wherein said at least one radially extending dampening projection has a longitudinal axis that is angularly offset relative to said longitudinal axis of said blade wing.

8. A cutter head according to claim 1, which includes a protection against rotation that is provided between said cutting blade and said contact or pressure piece that is provided with said at least one radially extending dampening projection, wherein said protection against rotation acts in at least one direction of rotation.

9. A cutter head according to claim 8, wherein said protection against rotation acts in both directions of rotation.

10. A cutter head according to claim 8, wherein said protection against rotation is a positive-connection protection against rotation that is provided between said radially extending dampening projection and an associated one of said blade wings.

11. A cutter head according to claim 10, wherein said positive-connection protection against rotation is in the form of a bent-over tab.

12. A cutter head according to claim 1, wherein said at least one contact or pressure piece is provided with a hub portion and a dampening portion that is disposed radially outwardly of said hub portion, and wherein measures for reducing mass are provided on said dampening projection in said dampening portion.

13. A cutter head according to claim 12, wherein said measures for reducing mass are, in the form of at least one of a width reduction, a thickness reduction, a recessed portion, and openings.

14. A cutter head according to claim 1, wherein a plurality of said dampening projections are stacked one above the other.

15. A cutter head according to claim 14, wherein said plurality of dampening projections respectively have different radial extensions.

16. A cutter head according to claim 1, wherein a radially outer end of said dampening projection is angled off toward said blade wing and rests against said blade wing with preload.

17. A cutter head according to claim 1, wherein at least said dampening projection and said contact or pressure piece that is provided with said at least one dampening projection are formed entirely of a light weight material having a specific mass that is less than a specific mass of said cutting blade.

18. A cutter head according to claim 17, wherein said light weight material is titanium.

19. A cutter head according to claim 1, wherein measures that increase frictional value are undertaken on a side of said dampening projection that faces said blade wing.

20. A cutter head according to claim 1, wherein a protection against losing of said contact or pressure piece that is provided with said at least one dampening projection relative to said cutting blade is provided.
